(19) United States
(12) Patent Application Publication
(10) Pub. No.: US 2025/0322754 A1
(43) Pub. Date: Oct. 16, 2025

(54) DISPLAY SYSTEM AND DISPLAY METHOD FOR WORK VEHICLE AND UNMANNED AERIAL VEHICLE

(71) Applicant: Kubota Corporation, Osaka (JP)

(72) Inventor: Kazuo SAKAGUCHI, Sakai-shi (JP)

(21) Appl. No.: 19/248,047

(22) Filed: Jun. 24, 2025

Related U.S. Application Data
(63) Continuation of application No. PCT/JP2022/048194, filed on Dec. 27, 2022.

(51) Int. Cl. G08G 5/23; G08G 5/21; G08G 5/26; G08G 5/54; G08G 5/56; G08G 7/00

(52) U.S. Cl. CPC G08G 5/23; G08G 5/21; G08G 5/26; G08G 5/54; G08G 5/56; G08G 7/00

(57) ABSTRACT

A display system displays, on a display, positions of a work vehicle and one or more unmanned aerial vehicles flying around the work vehicle. The display system includes a processor configured or programmed to obtain position information of the work vehicle and the unmanned aerial vehicles, and, based on the position information, display the positions of the work vehicle and the unmanned aerial vehicles in a field shown on the display.

### CROSS REFERENCE TO RELATED APPLICATIONS

This application is a Continuation Application of PCT Application No. PCT/JP2022/048194 filed on Dec. 27, 2022. The entire contents of this application are hereby incorporated herein by reference.

### BACKGROUND OF THE INVENTION

### 1. Field of the Invention

The present disclosure relates to display systems and display methods for work vehicles and unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

Japanese Patent Application Publication No. 2022-104737 describes an unmanned aerial vehicle (unmanned flying body) that changes its flight position in coordination with the operation of an agricultural machine.

### SUMMARY OF THE INVENTION

Example embodiments of the present disclosure provide display systems and display methods each to perform effective information display in a system including a work vehicle performing ground operations such as agricultural work or construction work, and provide unmanned aerial vehicles.

According to a non-limiting example embodiment of the present disclosure, a display system displays on a display positions of a work vehicle and one or more unmanned aerial vehicles flying around the work vehicle and includes a processor that obtains position information of the work vehicle and the unmanned aerial vehicles, and based on the position information, displays the positions of the work vehicle and the unmanned aerial vehicles in a field shown on the display.

According to example embodiments of the present disclosure, the positions of work vehicles and one or more unmanned aerial vehicles around the work vehicles can be displayed in fields shown on displays. This enables users to quickly grasp the positional relationships between the work vehicles and unmanned aerial vehicles.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers to rotate rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid drive type multicopter.

FIG. 2C is a block diagram showing a basic configuration example of a parallel hybrid drive type multicopter.

FIG. 3 is a diagram showing an example of a system including a multicopter and an agricultural work vehicle.

FIG. 4 is a block diagram showing an example configuration of the system shown in FIG. 3.

FIG. 5 is a flowchart showing an example of a communication method executed by a controller of a work vehicle or multicopter.

FIG. 6 is a first diagram explaining an example of a communication method in a system where a work vehicle and multicopter operate in coordination.

FIG. 7 is a second diagram explaining an example of a communication method in a system where a work vehicle and multicopter operate in coordination.

FIG. 8 is a flowchart showing an example where the communication mode changes in three stages according to the distance between a work vehicle and a multicopter.

FIG. 9 is a block diagram showing an example of the hardware configuration of the controller of a work vehicle.

FIG. 10 is a flowchart showing an example of a display method executed by the processor in the controller of a work vehicle.

FIG. 11 is a diagram showing an example of a map image displayed on a display.

### DETAILED DESCRIPTION OF THE EXAMPLE EMBODIMENTS

Unmanned aerial vehicles each include a plurality of rotors and a rotation driver to rotate the rotors (hereinafter referred to as “propellers”). Hereinafter, such an unmanned aerial vehicle is referred to as a “multicopter”.

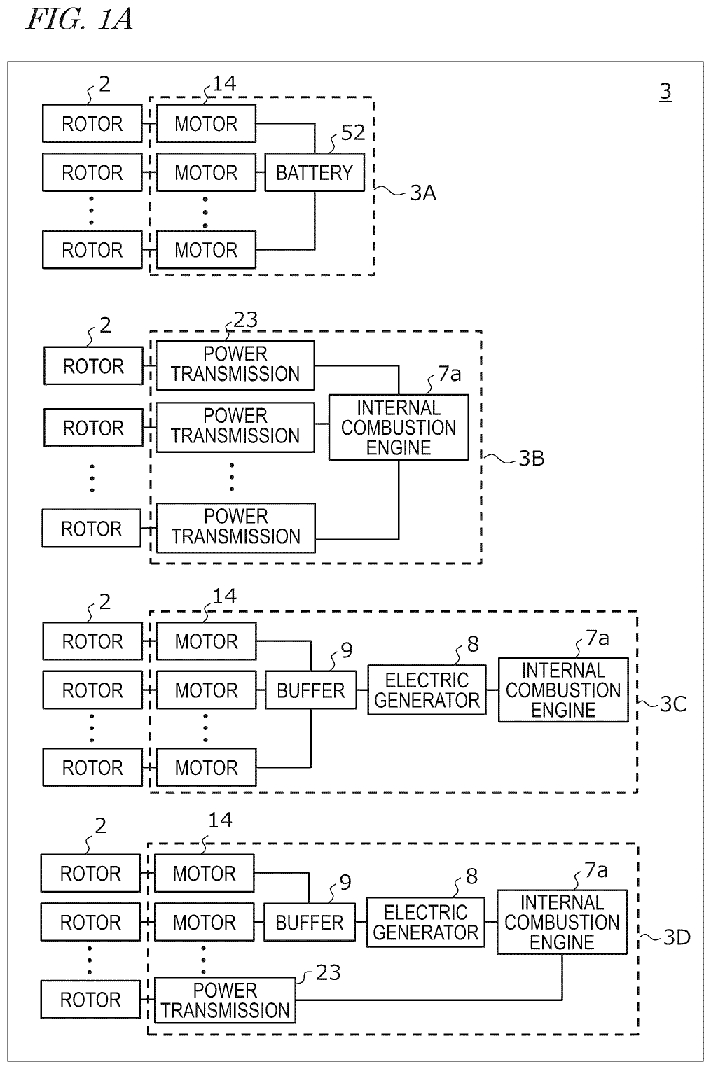

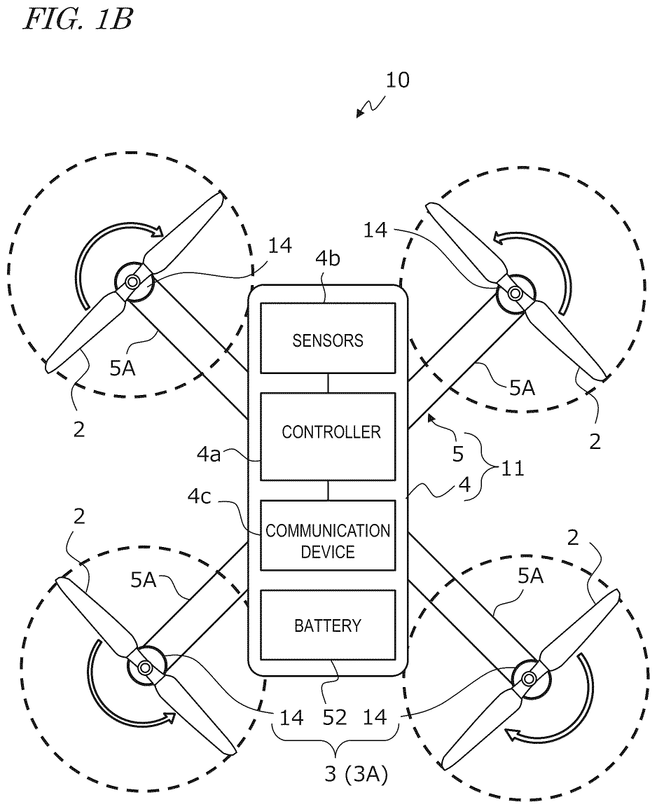

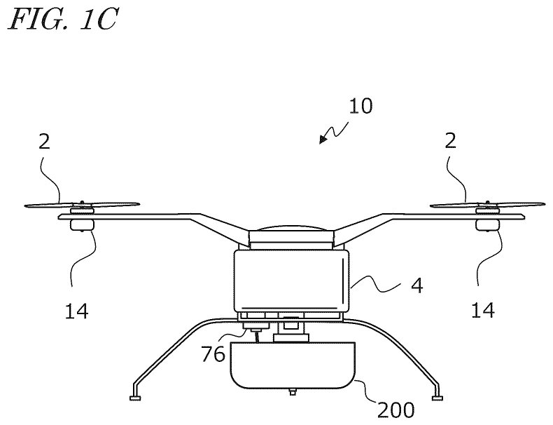

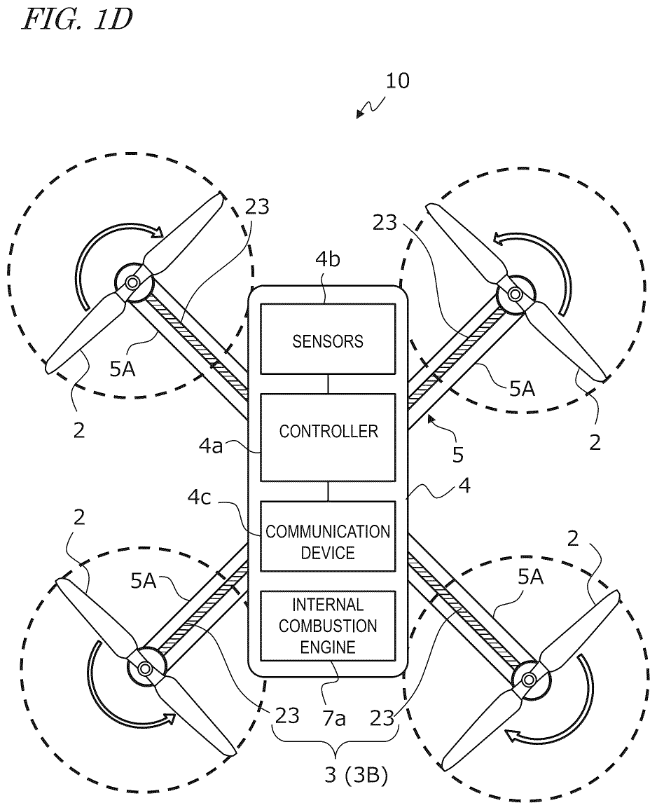

The configuration of rotation drivers included in multicopters exists in various forms. FIG. 1A is a schematic block diagram showing four examples of rotation drivers 3 according to example embodiments of the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of driver is called a “series hybrid driver”. The electric generator 8 and internal combustion engine 7a in a series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides driving force to the electric generator 8 for power generation, a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by the motor 14. In the fourth rotation driver 3D, since mechanical energy generated by internal combustion engine 7a can be utilized for rotor rotation without conversion to electrical energy, energy utilization efficiency can be enhanced. This type of driver is called a “parallel hybrid driver”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes motors 14 and a battery 52. FIG. 1C is a side view schematically showing the multicopter 10.

A multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A. The main body 4 and body frame 5 may be collectively referred to as “body 11”.

In the example of FIG. 1B, the multicopter 10 is a quad-type multicopter (quadcopter) including four rotors 2, for example. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, angular velocity sensor, geomagnetic sensor, atmospheric pressure sensor, altitude sensor, temperature sensor, flow sensor, imaging device, laser sensor, ultrasonic sensor, obstacle contact sensor, and GNSS (Global Navigation Satellite System) receiver. The acceleration sensor and angular velocity sensor may be mounted on the main body 4 as components of an IMU (Inertial Measurement Unit). Examples of laser sensors may include a laser range finder used to measure distance to the ground, and 2D or 3D LiDAR (light detection and ranging).

The communication device 4c may include a wireless communication module for signal transmission and reception with a ground-based transmitter or ground control station (GCS) via an antenna, and a mobile communication module that utilizes cellular communication networks. The communication device 4c is configured to receive signals such as control commands transmitted from the ground and transmit sensor data such as image data acquired by sensors 4b as telemetry information. The communication device 4c may also include functions for communication between multicopters and satellite communication capabilities. The controller 4a may connect to computers in the cloud through the communication device 4c. The computer in the cloud may execute part or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are included, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned further inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 has a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23. Rotation driver 3B may include a mechanism to change the pitch angle of blades of each of the plurality of rotors 2. In that case, the controller 4a may adjust the lift generated by each rotor 2 by controlling that mechanism to change the blade pitch angles.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid driver, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used to generate thrust, and the sub-rotors are used for both generating thrust and attitude control. The main rotors may be called “booster rotors” and the sub-rotors may be called “attitude control rotors”.

In the parallel hybrid driver, the internal combustion engine is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine and uses the internal combustion engine for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt a parallel hybrid driver or a series hybrid driver to increase payload and flight duration. Note that when the rotation driver 3 includes a mechanism to change the pitch angle of blades of each of the plurality of the rotors 2, the attitude can also be adjusted by changing the pitch angle of each blade.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may include mechanisms such as robotic hands. In that case, a single implement 200 can perform various ground operations. When the implement 200 includes space large enough to store materials, the implement 200 can also transport agricultural materials or harvested crops over a wide area. There are various forms of connecting the implement 200 to the multicopter 10. The multicopter 10 may suspend and tow the implement 200 using a cable. The implement 200 towed by the multicopter 10 can perform ground operations while being towed during flight or hovering of multicopter 10. The implement 200 during operation may be in the air or on the ground.

In the example shown in FIG. 1C, the multicopter 10 includes power supply 76. The power supply 76 supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery to store power.

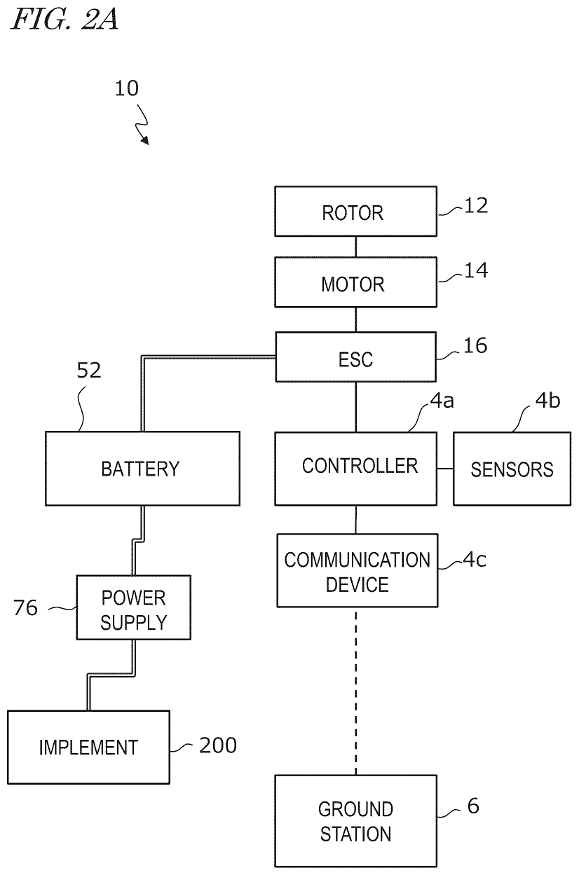

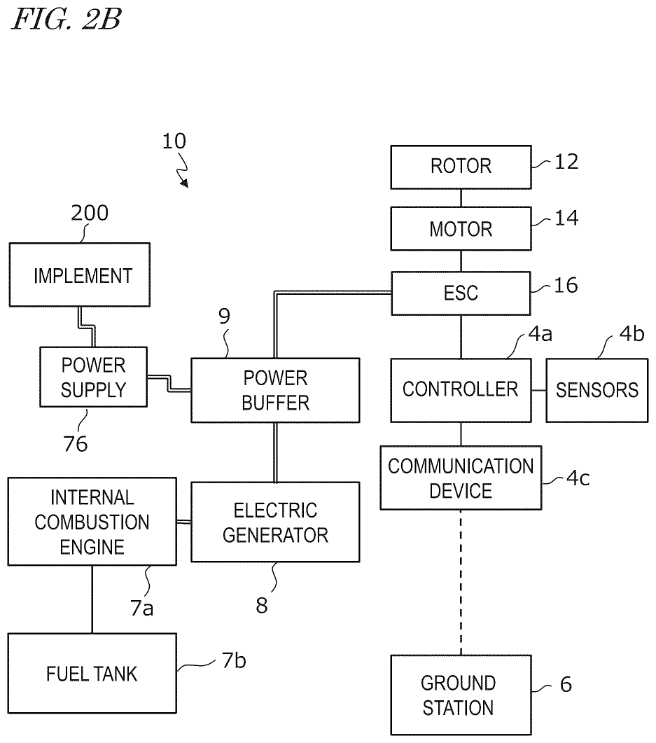

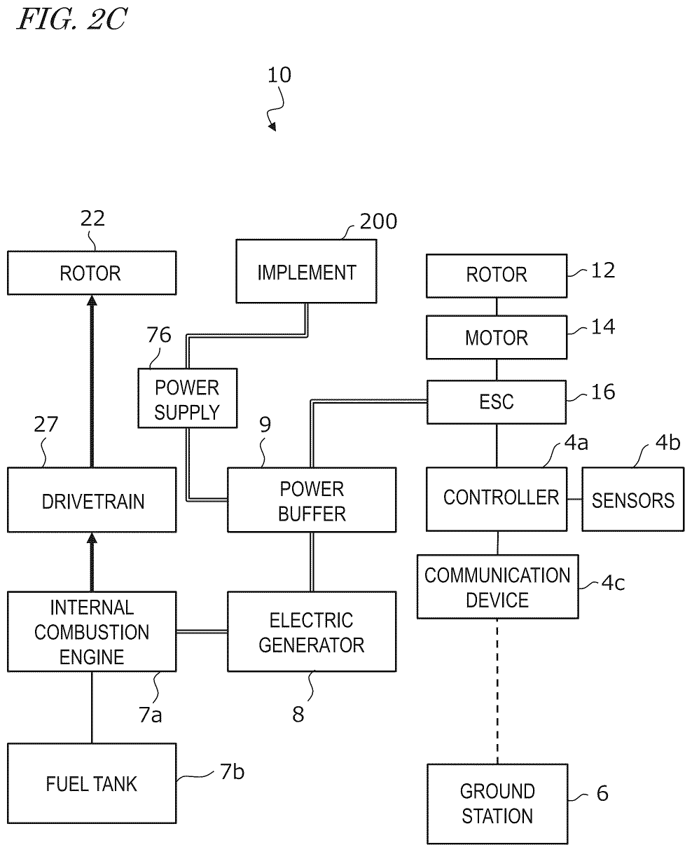

FIG. 2A shows a block diagram of a basic configuration example of a battery-driven multicopter 10. The battery-driven multicopter 10 includes a plurality of rotors 12, a plurality of motors 14, each driving a respective one of the plurality of rotors 12, a plurality of ESCs (Electric Speed Controllers) 16 each including a motor drive circuit that drives a respective one of the plurality of motors 14, a battery 52 that supplies power to each of the plurality of motors 14 through each respective ESC 16, a controller 4a configured or programmed to control a plurality of ESCs 16 to control attitude while flying, sensors 4b, a communication device 4c, and a power supply 76 that is electrically connected to the battery 52. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C. The ESC 16 may be included in the controller 4a.

The controller 4a may receive control commands wirelessly from, for example, a ground station 6 on the ground through the communication device 4c. The number of ground stations 6 is not limited to one, and the grand station 6 may be distributed across a plurality of locations. The communication device 4c may also wirelessly receive control commands from an operator's remote controller on the ground. The controller 4a may be configured or programmed to perform functions to automatically or autonomously execute takeoff, flight, obstacle avoidance, and landing operations based on sensor data obtained from the sensors 4b. The controller 4a may be configured or programmed to communicate with the implement 200 connected to the power supply 76 and obtain signals indicating the state of the implement 200 from the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless methods or mechanisms.

FIG. 2B is a block diagram showing a basic configuration example of a series hybrid drive type multicopter 10. Like the battery-driven multicopter 10, the series hybrid drive type multicopter 10 includes a plurality of rotors 12, a plurality of motors 14, a plurality of ESCs 16, a controller 4a, sensors 4b, and a communication device 4c. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid drive type multicopter 10. Like the series hybrid drive type multicopter 10, the parallel hybrid drive type multicopter 10 includes a plurality of rotors 12, a plurality of motors 14, each driving a respective one of the plurality of rotors 12, a plurality of ESCs 16, a controller 4a, sensors 4b, a communication device 4c, an internal combustion engine 7a, a fuel tank 7b, an electric generator 8, a power buffer 9, and a power supply 76. The parallel hybrid drive type multicopter 10 further includes a drivetrain 27 that transmits a driving force from the internal combustion engine 7a, and the rotor 22 that rotates upon the receiving driving force from the internal combustion engine 7a through the drivetrain 27. The rotor 12 and rotor 22 may be distinguished by calling one “first rotor” and the other “second rotor”. The number of rotors 22 connected to drivetrain 27 and rotated may be one or two or more.

In the parallel hybrid drive type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

As described above, the configuration of multicopter 10 is diverse. Multicopter 10 can perform tasks such as spraying chemicals, fertilizers, or seeds in fields, or performing operations like mowing by suspending implements. Additionally, multicopter 10 may also be used for applications that support ground operations performed by industrial machinery (such as agricultural or construction machinery) in coordination with the machinery. Agricultural machinery includes agricultural work vehicles such as tractors, combines, rice transplanters, and riding cultivators. Construction machinery includes construction and civil engineering work vehicles such as backhoes, wheel loaders, and carriers. Ground operations refer to operations performed on the ground, including agricultural tasks such as tilling, seeding, pest control, fertilizing, planting, and harvesting, as well as construction and civil engineering tasks such as ground excavation.

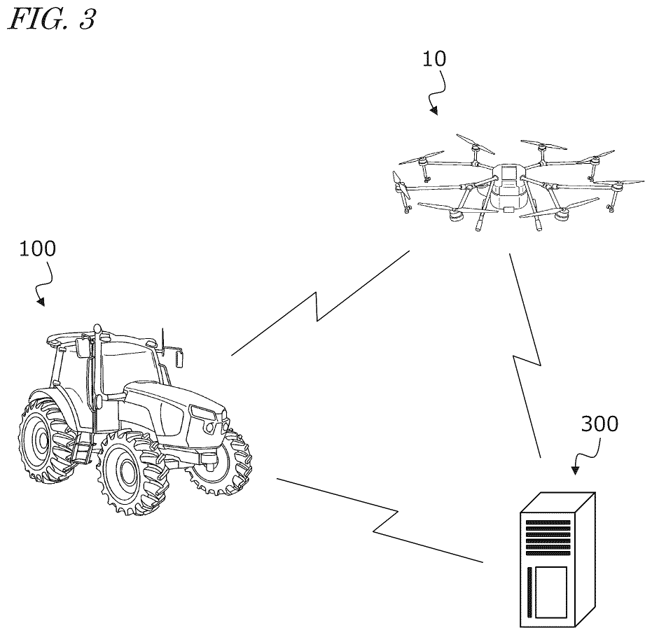

FIG. 3 shows an example of a system that includes a multicopter 10 and an agricultural work vehicle 100. In this example, the work vehicle 100 is an agricultural tractor. The work vehicle 100 may be agricultural machinery other than a tractor or may be construction machinery. FIG. 3 also shows a server 300 that communicates with the multicopter 10 and the work vehicle 100. The server 300 may be a cloud server computer installed in a data center or similar facility. The server 300 can communicate with the work vehicle 100 and the multicopter 10 via intermediary devices (such as multiple routers and switches within the network). Direct wireless communication and indirect communication via server 300 are both possible between the work vehicle 100 and the multicopter 10. Note that while FIG. 3 shows one work vehicle 100 and one multicopter 10 as examples, the number of work vehicles 100 and multicopters 10 may each be two or more.

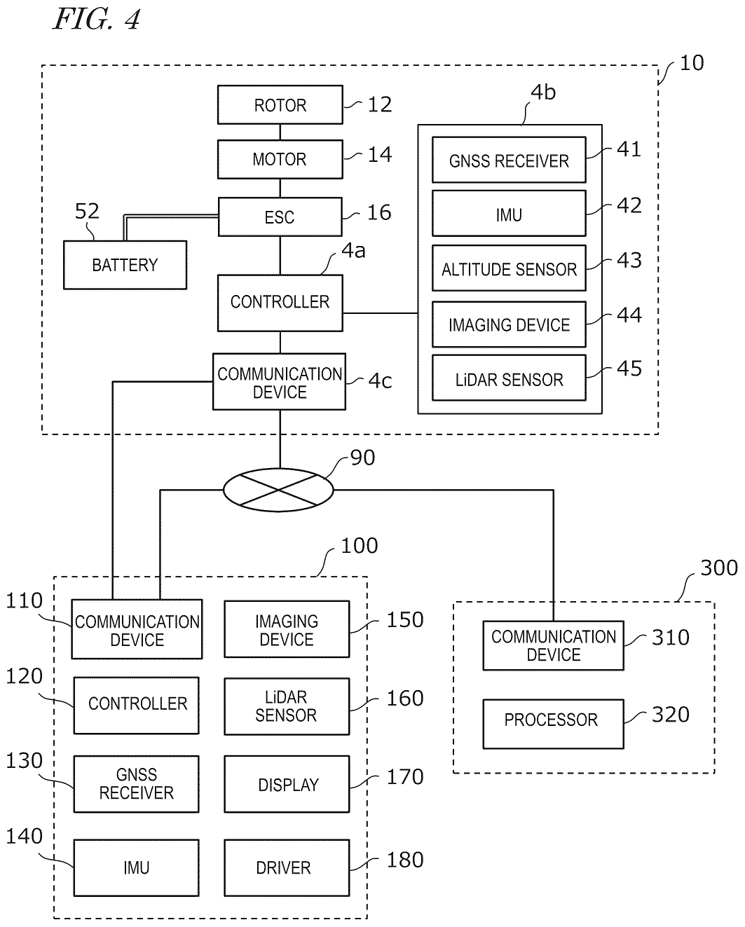

FIG. 4 is a block diagram showing an example configuration of the system shown in FIG. 3. In the example of FIG. 4, the multicopter 10, similar to the example shown in FIG. 2A, includes a plurality of rotors 12, a plurality of motors 14 each driving respective one of the plurality of rotors 12, a battery 52 that stores electric power, a controller 4a that controls the flight of the multicopter 10, a communication device 4c, and sensors 4b. Note that the power supply 76 and implement 200 shown in FIG. 2A are omitted from FIG. 4. In FIG. 4, for simplicity, the rotor 12, the motor 14, and the ESC 16 are each shown by a single block, but the numbers of rotors 12, motors 14, and ESCs 16 are each plural. Additionally, the multicopter 10 may include at least one second rotor 22 driven by an internal combustion engine 7a, as shown in FIG. 2B or FIG. 2C. In that case, either a “series hybrid” or a “parallel hybrid” drive format may be adopted.

FIG. 4 shows examples of sensors 4b including a GNSS receiver 41, an IMU 42, an altitude sensor 43, an imaging device 44, and a LIDAR sensor 45. The GNSS receiver 41 and IMU 42 serve as positioning devices that measure the position and attitude (pose) of the multicopter 10. The altitude sensor 43 measures the altitude of the multicopter 10 body and outputs a signal indicating this altitude. Altitude refers to the vertical distance between a reference surface (such as the ground surface) and the body. The altitude sensor 43 may be implemented, for example, using a barometer, a distance measuring device that measures the distance from the body to the ground, or a combination of these. The imaging device 44 generates and outputs image data by capturing the surroundings of the multicopter 10. The LiDAR sensor 45 is an example of a distance measuring device that measures the distance to objects existing around the multicopter 10. The imaging device 44 and LiDAR sensor 45 are external sensors that sense the environment around the multicopter 10 and output sensor data.

The controller 4a controls the operations of the multicopter 10 including flight and communication. The communication device 4c is a communication module that communicates with external devices such as the work vehicle 100 and server 300. The communication device 4c may be configured to perform wireless communication using, for example, Wi-Fi (Wireless Fidelity, registered trademark), BLE (Bluetooth Low Energy), LPWA (Low Power Wide Area), specified low-power radio, or cellular communication networks such as 4G or 5G. The communication device 4c can communicate with the communication device 110 in the work vehicle 100 either directly or indirectly via the network 90 and server 300.

In the example of FIG. 4, the work vehicle 100 includes a communication device 110, a controller 120, a GNSS receiver 130, an IMU 140, an imaging device 150, and a LIDAR sensor 160. The functions of these devices are similar to those of the corresponding devices in the multicopter 10. The work vehicle 100 further includes a display 170 and a driver 180 that includes an engine and driving equipment, etc.

The communication device 110 can communicate with the communication device 4c of the multicopter 10 either directly or indirectly via the network 90 and server 300. The controller 120 is configured or programmed to control the operation of the work vehicle 100. The GNSS receiver 130 and IMU 140 function as positioning devices that measure the position and attitude of the work vehicle 100. The imaging device 150 and LIDAR sensor 160 function as external sensors that sense the environment around the work vehicle 100 and output sensor data. The display 170 displays a map of the area where the work vehicle 100 is traveling, and information such as the position and speed of both the work vehicle 100 and the multicopter 10. The display 170 may be a terminal installed in the work vehicle 100 for operation, or it may be a mobile terminal used by a user of the work vehicle 100.

The server 300 includes a communication device 310 that communicates with the communication device 4c of the multicopter 10 and the communication device 110 of the work vehicle 100 via the network 90, and a processor 320 configured or programmed to execute processing based on information obtained from the multicopter 10 and the work vehicle 100.

In the example shown in FIG. 4, the multicopter 10 includes a communication system that includes the communication device 4c and the controller 4a. Similarly, the work vehicle 100 includes a communication system that includes the communication device 110 and the controller 120. These communication systems execute communication that enables the multicopter 10 and the work vehicle 100 to operate in coordination. Below, examples of the operation of the communication systems mounted on the multicopter 10 and the work vehicle 100 will be explained.

The controller 4a in the multicopter 10 is configured or programmed to control communication through the communication device 4c. The controller 4a changes the mode of communication with the work vehicle 100 according to the distance between the work vehicle 100 and the multicopter 10. Similarly, the controller 120 in the work vehicle 100 is configured or programmed to control communication through the communication device 110. The controller 120 changes the mode of communication with the multicopter 10 according to the distance between the work vehicle 100 and the multicopter 10.

The change in communication mode may include, for example, changes in the type of data transmitted, the frequency of communication, the volume of communication, or the communication method. For example, when the distance between the work vehicle 100 and the multicopter 10 is greater than a threshold (i.e., when they are far apart), they may share sensing information with each other. Sensing information may be obtained by external sensors such as imaging devices 44, 150, LiDAR sensors 45, 160, etc. Conversely, when the distance between the work vehicle 100 and the multicopter 10 is less than or equal to the threshold (i.e., when they are close), they may share information necessary for collision avoidance (such as position information, attitude information, and/or altitude information). Position information may be obtained by positioning devices such as GNSS receivers 41, 130. Attitude information may be obtained by attitude detection sensors such as IMUs 42, 140. Altitude information may be obtained by the altitude sensor 43. Alternatively, when they are far apart, they may communicate indirectly via external computers such as server 300, and when they are close, they may communicate directly via wireless communication.

The distance between the work vehicle 100 and the multicopter 10 may be calculated based on the respective position information output from the positioning devices (e.g., GNSS receivers 130 and 41) mounted on each of the work vehicle 100 and the multicopter 10. That is, the controllers 120 and 4a may be configured or programmed to obtain position information of the work vehicle 100 from the positioning device mounted on the work vehicle 100, obtain position information of the multicopter 10 from the positioning device mounted on the multicopter 10, and calculate the distance between the work vehicle 100 and the multicopter 10 based on these position information. Alternatively, the controllers 120 and 4a may obtain information indicating the distance between the work vehicle 100 and the multicopter 10 from a distance measuring device (such as LIDAR sensors 160 or 45) mounted on the work vehicle 100 or the multicopter 10. Additionally, the distance between the work vehicle 100 and the multicopter 10 may be measured using a beacon transmitter mounted on one of the work vehicle 100 and the multicopter 10, and a beacon receiver mounted on the other.

Below, several examples of methods to change communication modes according to the distance between the work vehicle 100 and the multicopter 10 will be explained. In the following explanation, unless otherwise specified, the acting entity will be the controller 4a in the multicopter 10. Each of the communication methods explained below may also be executed similarly by the controller 120 in the work vehicle 100. This enables sharing of information between the work vehicle 100 and the multicopter 10.

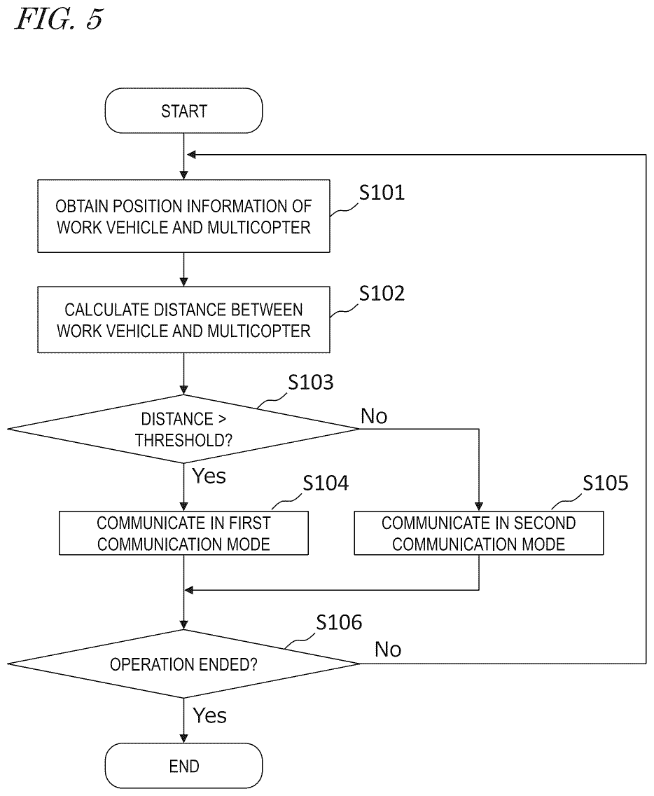

FIG. 5 is a flowchart showing an example of a communication method executed by the controller 4a.

In step S101, the controller 4a obtains the respective position information of the work vehicle 100 and the multicopter 10 from their respective positioning devices. The position information may include, for example, latitude and longitude information measured by the GNSS receiver 41.

In step S102, the controller 4a calculates the distance between the work vehicle 100 and the multicopter 10 based on the obtained position information. The controller 4a can calculate the distance between the two by taking the difference between the position of the work vehicle 100 and the position of the multicopter 10.

Note that instead of the operations in steps S101 and S102, distance information between the work vehicle 100 and the multicopter 10 may be obtained using a distance measuring device or beacon as described above.

In step S103, the controller 4a compares the calculated distance with a threshold. The threshold is previously stored in a storage device such as the memory of the controller 4a. The threshold is a predetermined value such as 5 m, 10 m, or 20 m, and is determined according to the purpose or application of the system. If the distance is greater than the threshold, proceed to step S104. If the distance is less than or equal to the threshold, proceed to step S105.

In step S104, the controller 4a executes communication with the work vehicle 100 in a first communication mode. In the first communication mode, the controller 4a may be configured or programmed to transmit position information obtained from the positioning device (e.g., GNSS receiver 41) of the multicopter 10 to the work vehicle 100 via the communication device 4c. Alternatively, in the first communication mode, the controller 4a may transmit sensor data obtained from external sensors (such as imaging device 44 or LiDAR sensor 45) mounted on the multicopter 10 to the work vehicle 100 via the communication device 4c. The controller 4a may transmit both position information and sensor data to the work vehicle 100 in the first communication mode. By transmitting position information and/or sensor data to the work vehicle 100, the controller 120 of the work vehicle 100 can, for example, display information such as the position of the multicopter 10 or images obtained by sensing on the display 170.

In step S105, the controller 4a is configured or programmed to perform communication with the work vehicle 100 in a second communication mode that is different from the first communication mode. In the second communication mode, the controller 4a may be configured or programmed to transmit, in addition to position information and/or sensor data, attitude information obtained from the attitude detection sensor (e.g., IMU 42) mounted on the multicopter 10 and/or altitude information obtained from the altitude sensor 43 to the work vehicle 100 via the communication device 4c. By transmitting attitude information and/or altitude information in addition to position information to the work vehicle 100, it becomes easier for the work vehicle 100 to detect the multicopter 10 as an obstacle, making it easier to avoid collision between the work vehicle 100 and the multicopter 10.

Communication in the first communication mode in step S104 and communication in the second communication mode in step S105 may each be repeated at predetermined time intervals. In that case, communication in the second communication mode may be executed at shorter time intervals than communication in the first communication mode. Also, in communication in the first communication mode in step S104, the controller 4a may be configured or programmed to indirectly transmit data to the work vehicle 100 via an external computer, the server 300 in the cloud, using public networks such as 4G or 5G. This is because when the distance between the work vehicle 100 and the multicopter 10 is large, there is no possibility of collision between them, so the speed and frequency of communication between them can be low. Conversely, in communication in the second communication mode in step S105, the controller 4a may be configured or programmed to directly transmit data to the work vehicle 100 using wireless communication such as Wi-Fi (registered trademark), Bluetooth, or specified low-power radio. This is because when the distance between the work vehicle 100 and the multicopter 10 is short, to avoid collision, it is desirable to increase the speed and frequency of communication between them, exchanging information such as position and attitude at short time intervals.

In step S106, the controller 4a determines whether to end the operation. For example, if a pre-programmed flight has ended, or if an instruction to end the operation has been received from an external device such as a controller or remote monitoring device, the controller 4a ends the operation. The controller 4a repeats the operations from steps S101 to S106 until it determines to end the operation.

The operations shown in FIG. 5 may be executed not only by the controller 4a of the multicopter 10 but also by the controller 120 of the work vehicle 100. That is, the controller 120 of the work vehicle 100 may transmit position information obtained from the positioning device (e.g., GNSS receiver 130) mounted on the work vehicle 100 to the multicopter 10 via the communication device 110 when the distance between the work vehicle 100 and the multicopter 10 is greater than the threshold. The controller 120 may also transmit sensor data obtained from external sensors (such as imaging device 150 or LIDAR sensor 160) mounted on the work vehicle 100 to the multicopter 10 via the communication device 110 when that distance is greater than the threshold. Conversely, when that distance is less than or equal to the threshold, the controller 120 may transmit attitude information obtained from the attitude detection sensor (e.g., IMU 140) mounted on the work vehicle 100 in addition to position information to the multicopter 10 via the communication device 4c. Furthermore, when that distance is greater than the threshold, the controller 120 may execute communication with the multicopter 10 via the server 300, and when that distance is less than or equal to the threshold, it may execute direct communication with the multicopter 10.

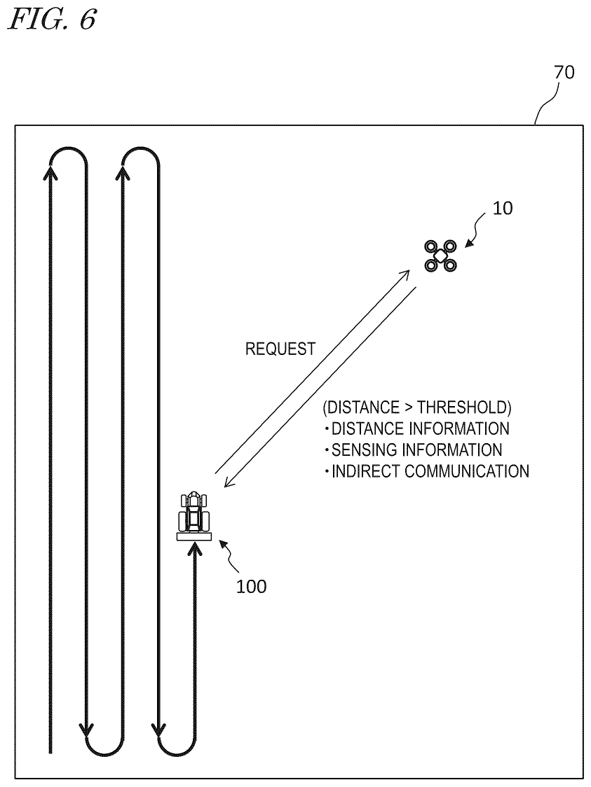

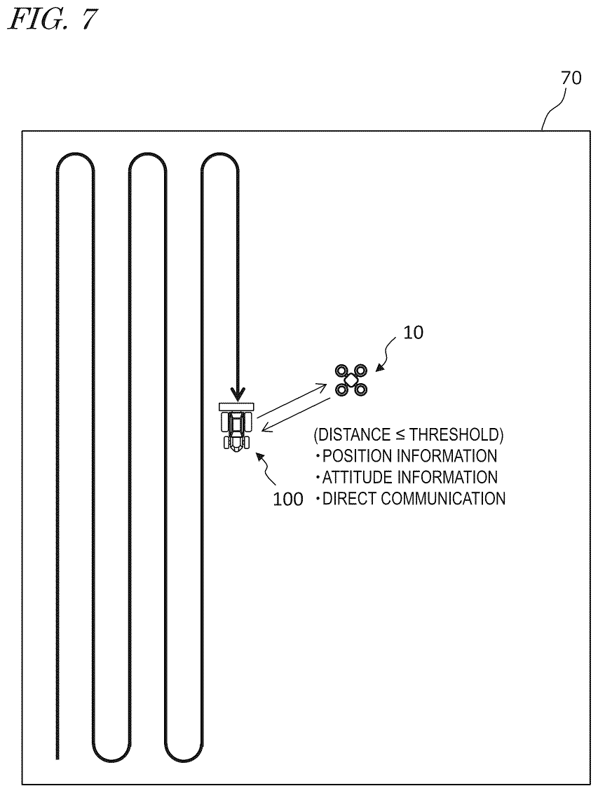

Next, more specific examples of the communication method according to this example embodiment will be explained with reference to FIGS. 6 and 7.

FIGS. 6 and 7 show an example of a communication method in a system where the work vehicle 100 and the multicopter 10 operate in coordination. FIG. 6 shows a state where the distance between the work vehicle 100 and the multicopter 10 is greater than the threshold. FIG. 7 shows a state where the distance between the work vehicle 100 and the multicopter 10 is less than or equal to the threshold.

In this example, the work vehicle 100 travels along a predetermined travel path while performing agricultural work such as spreading fertilizer, chemicals, or seeds, planting crop seedlings, harvesting crops, or mowing grass in a field 70. The work vehicle 100 shown in FIG. 6 is a tractor that performs agricultural work by driving the implement connected to the work vehicle 100. The work vehicle 100 is not limited to tractors but may be, for example, a transplanter such as a rice transplanter, or a harvester such as a combine. Furthermore, the work vehicle 100 is not limited to agricultural machinery and may be construction machinery.

The travel path of the work vehicle 100 shown in FIG. 6 meanders regularly as indicated by the thick arrows in the figure. The work vehicle 100 may travel by manual driving by a user or by autonomous driving. In the case where the work vehicle 100 travels by autonomous driving, map information of the field 70 and information on the travel path are previously recorded in the storage device of the work vehicle 100. The controller 120 can make the work vehicle 100 travel along the pre-set travel path based on position information and attitude information output from the positioning device including the GNSS receiver 130 and IMU 140.

The multicopter 10 flies around the work vehicle 100 and supports the ground operations performed by the work vehicle 100. For example, when the work vehicle 100 performs spreading of fertilizer, chemicals, or seeds, or planting of crop seedlings, the multicopter 10 may be configured or programmed to perform the transport operation of delivering such agricultural materials to the work vehicle 100 when the remaining amount of agricultural materials (fertilizer, chemicals, seeds, or seedlings, which may hereinafter be referred to as “agricultural materials” or simply “materials”) becomes low. Alternatively, when the work vehicle 100 is a harvester that harvests crops, the multicopter 10 may be configured or programmed, for example, to receive harvested crops accumulated in the tank of the work vehicle 100 and transport them to a designated location.

In such a system, the work vehicle 100 may include sensors that measure the remaining amount of materials or the amount of harvested crops. The controller 120 may be configured or programmed to transmit a request to call the multicopter 10 to the multicopter 10 by controlling the communication device 110 based on signals output from the sensors. The controller 4a of the multicopter 10 may be configured or programmed to fly the multicopter 10 to the vicinity of the work vehicle 100 in response to the request from the work vehicle 100.

While the multicopter 10 is flying, the controller 4a executes the operations shown in FIG. 5. That is, the controller 4a determines whether the distance between the work vehicle 100 and the multicopter 10 is greater than the threshold. If that distance is greater than the threshold, it performs communication using the first communication mode, and when that distance becomes less than or equal to the threshold, it changes the communication mode from the first communication mode to the second communication mode. FIG. 6 shows an example of communication using the first communication mode, and FIG. 7 shows an example of communication using the second communication mode. In the first communication mode shown in FIG. 6, the controller 4a of the multicopter 10 transmits position information obtained by the GNSS receiver 41 and sensing information obtained by the imaging device 150 and LiDAR sensor 160 to the work vehicle 100. Also, communication between the multicopter 10 and the work vehicle 100 is conducted indirectly via the server 300. In contrast, in the second communication mode shown in FIG. 7, the controller 4a transmits position information obtained by the GNSS receiver 41 and attitude information obtained by the IMU 140 to the work vehicle 100. Also, communication between the multicopter 10 and the work vehicle 100 is conducted through direct wireless communication. This allows high-frequency transmission of position information and attitude information to the work vehicle 100 when the multicopter 10 approaches the work vehicle 100, making it easier for the work vehicle 100 to accurately grasp the position and attitude of the multicopter 10 based on that information. This enables the work vehicle 100 to perform proper alignment for the handover of materials or harvested crops without colliding with the multicopter 10.

In both the first communication mode and the second communication mode, not only may information be transmitted from the multicopter 10 to the work vehicle 100, but information may also be transmitted from the work vehicle 100 to the multicopter 10. For example, in the first communication mode, the work vehicle 100 and the multicopter 10 may share each other's position information and/or sensing information. In the second communication mode, the work vehicle 100 and the multicopter 10 may share each other's position information and/or attitude information. By transmitting this information from the work vehicle 100 to the multicopter 10, it becomes easier for the multicopter 10 to accurately grasp the position and attitude of the work vehicle 100. This enables the multicopter 10 to position itself properly for handover of materials or harvested crops without colliding with the work vehicle 100.

Thus, bidirectional communication may be conducted between the multicopter 10 and the work vehicle 100, or unidirectional communication may be conducted from one to the other.

Note that the changes in the information transmitted and the communication method in the first communication mode and the second communication mode in the examples of FIGS. 6 and 7 are merely illustrative, and various modifications are possible. For example, the controller 4a of the multicopter 10 may transmit position information in the first communication mode, and in the second communication mode, may transmit altitude information obtained by the altitude sensor 43 in addition to position information and attitude information to the work vehicle 100. Adding altitude information enables the work vehicle 100 to grasp the position of the multicopter 10 more accurately. Also, the controller 4a or the controller 120 may transmit the same type of information in both the first communication mode and the second communication mode, but may make the communication frequency in the second communication mode higher than the communication frequency in the first communication mode. For example, information may be transmitted at a first time interval (e.g., about 0.1 seconds or more and less than about 1 second) in the first communication mode, and at a shorter second time interval (e.g., about 0.01 seconds or more and less than about 0.1 seconds) in the second communication mode.

In the examples of FIGS. 6 and 7, the multicopter 10 supports the work of the work vehicle 100, but these roles may be reversed. For example, the multicopter 10 may perform ground operations such as spraying agricultural materials like chemicals, fertilizers, or seeds, harvesting crops, or mowing grass by driving the implement 200 as shown in FIG. 1C, and the work vehicle 100 may provide support such as transporting agricultural materials, harvested crops, or cut grass. In that case as well, the communication method described above can be applied similarly.

In the above examples, the multicopter 10 receives position information of the work vehicle 100 measured by the positioning device of the work vehicle 100, and the work vehicle 100 obtains position information of the multicopter 10 measured by the positioning device of the multicopter 10. The position information of each communication partner is not limited to being obtained from that communication partner. For example, each of the multicopter 10 and the work vehicle 100 may estimate the position of the communication partner based on data output from its sensing device such as an imaging device and/or LiDAR sensor. For example, they may recognize the communication partner based on image data output from a sensing device such as a stereo camera and/or distance data or point cloud data output from a laser sensor such as a LiDAR sensor, and identify its position.

Thus, the communication method of this example embodiment enables sharing of necessary information between the work vehicle 100 and the multicopter 10 with high accuracy and in real-time. This allows the work vehicle 100 and the multicopter 10 to approach without colliding, making it possible to perform cooperative work such as material replenishment or handover of harvested materials. For example, it is possible for the work vehicle 100 and the multicopter 10 to perform cooperative work such that their positions overlap in a plan view without making contact. Such cooperative work may also be referred to as “collaborative work”.

In the above examples, the communication mode is changed based on the comparison result of the distance between the work vehicle 100 and the multicopter 10 with a single threshold, but the communication mode may be changed in multiple stages based on the comparison results with two or more thresholds.

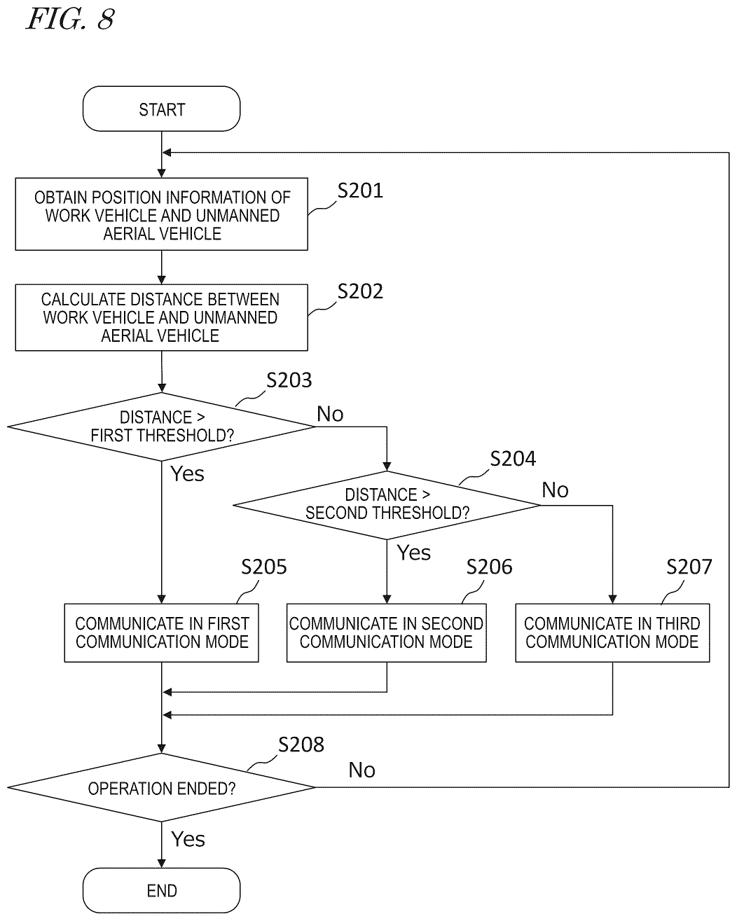

FIG. 8 is a flowchart showing an example where the communication mode changes in three stages according to the distance between the work vehicle 100 and the multicopter 10. The operations shown in FIG. 8 may be executed by either or both of the controller 4a of the multicopter 10 and the controller 120 of the work vehicle 100. Below, it will be explained assuming that the controller 4a of the multicopter 10 executes the operations shown in FIG. 8. In this example, the operations in steps S201, S202, and S208 are the same as the operations in steps S101, S102, and S106 respectively, so their explanation is omitted.

In step S203, the controller 4a determines whether the distance between the work vehicle 100 and the multicopter 10 is greater than a first threshold. If the distance is greater than the first threshold, proceed to step S205, and the controller 4a performs communication in the first communication mode. After step S205, proceed to step S208. If the distance is less than or equal to the first threshold, proceed to step S204.

In step S204, the controller 4a determines whether the distance between the work vehicle 100 and the multicopter 10 is greater than a second threshold that is smaller than the first threshold. If the distance is greater than the second threshold, proceed to step S206, and the controller 4a performs communication in the second communication mode. After step S206, proceed to step S208. If the distance is less than or equal to the second threshold, proceed to step S207, and the controller 4a performs communication in the third communication mode. After step S207, proceed to step S208.

The operations shown in FIG. 8 allow the communication mode to be changed in three stages according to the distance between the work vehicle 100 and the multicopter 10. The first communication mode may be a mode that transmits position information through indirect communication. The second communication mode may be a mode that transmits position information and attitude information through direct communication. The third communication mode may be a mode that transmits position information, attitude information, and altitude information through direct communication. Sensing information may also be transmitted in each mode. In this way, by transmitting more types of information or increasing the communication speed or transmission frequency as the distance between the work vehicle 100 and the multicopter 10 becomes shorter, information communication for coordination between the work vehicle 100 and the multicopter 10 can be executed more appropriately. Note that the controllers 4a and 120 may change the communication mode in four or more stages according to the distance between the work vehicle 100 and the multicopter 10.

The information communication method in this disclosure is not limited to the above examples. Below, other communication methods are exemplified.

The controllers 4a and 120 may share position information measured by their respective positioning devices when the distance between the multicopter 10 and the work vehicle 100 is longer than the threshold, and may share more detailed information about relative position obtained using imaging devices or beacons when the distance falls below the threshold.

The controller 4a of the multicopter 10 may switch sensors used for sensing, such as LiDAR, depending on the relative position to the work vehicle 100. For example, when the multicopter 10 is flying at a position higher than the height of the work vehicle 100, it may transmit sensor data obtained by sensors that sense the area below the multicopter 10, and when the multicopter 10 is flying at a position lower than the height of the work vehicle 100, it may transmit sensor data obtained by sensors that sense the area to the side of the multicopter 10.

The communication method may be changed depending on the relative speed between the work vehicle 100 and the multicopter 10 in addition to the distance between them. For example, communication may be conducted via public lines and server 300 when the relative speed is less than or equal to a threshold, and direct communication may be conducted between the work vehicle 100 and the multicopter 10 when the relative speed exceeds the threshold.

The controller 120 in this example embodiment also may be configured or programmed to function as a display system that displays on the display 170 the positions of the work vehicle 100 and one or more multicopters 10 flying around the work vehicle 100. The display system is a system capable of displaying on the display 170 the relative positions of the work vehicle 100, which can perform ground operations while moving, and the flying multicopter 10.

The controller 120 includes a processor configured or programmed to obtain position information of the work vehicle 100 and the unmanned aerial vehicle 10, and based on the position information, display the positions of the work vehicle 100 and the unmanned aerial vehicle 10 in a field (i.e., display area) shown on the display 170. The display 170 may be included in the display system or may be an element external to the display system.

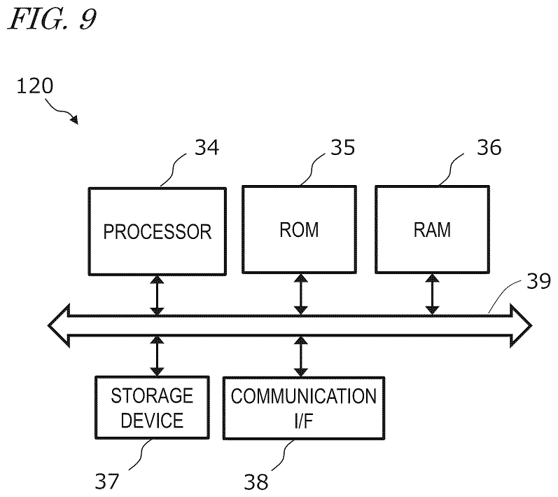

FIG. 9 is a block diagram showing an example of the hardware configuration of the controller 120. The controller 120 includes a processor 34 which is a processor, a ROM (Read Only Memory) 35, a RAM (Random Access Memory) 36, a storage device 37, and a communication I/F 38. These components are interconnected via a bus 39.

The processor 34 is one or more semiconductor integrated circuits, also referred to as a central processing unit (CPU) or microprocessor. The processor sequentially executes computer programs stored in the ROM 35 to implement various processes. The processor is broadly interpreted to include terms such as FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (for example, PROM), rewritable memory (for example, flash memory), or read-only memory. The ROM 35 stores programs that control the operation of the processor. The ROM 35 need not be a single recording medium but may be a collection of a plurality of recording media. Part of the plurality of collections may be removable memory.

The RAM 36 provides a work area for temporarily expanding programs stored in the ROM 35 during boot-up. The RAM 36 need not be a single recording medium but may be a collection of a plurality of recording media.

The communication I/F 38 is an interface for communication between the controller 120 and other electronic components or electronic control units (ECUs). For example, the communication I/F 38 may perform wired communication complying with various protocols. The communication I/F 38 may also perform wireless communication complying with Bluetooth® standards and/or Wi-Fi® standards. Both standards include wireless communication standards utilizing the 2.4 GHz frequency band.

The storage device 37 may be, for example, a semiconductor memory, magnetic storage device, or optical storage device, or a combination thereof. The storage device 37 is configured to store, for example, map data (map information) useful for autonomous driving of the work vehicle 100, and various sensor data acquired by the work vehicle 100 while traveling.

Note that the controller 4a of the multicopter 10 may also have a hardware configuration similar to that shown in FIG. 9. The controller 4a, as mentioned earlier, may be configured or programmed to include, for example, a flight controller such as a flight controller and a higher-level computer (companion computer). The companion computer may execute the various processes described above and provide instructions related to flight to the flight controller based on the results of those processes.

In this example embodiment, the display 170 is mounted on the work vehicle 100. The display 170 may be embedded in or connected to a computer used by a user who monitors the operation of the work vehicle 100 from a location spaced away from the work vehicle 100. The computer used by the user may be a mobile terminal such as a smartphone or tablet computer, or it may be a stationary computer such as a personal computer (PC) or workstation.

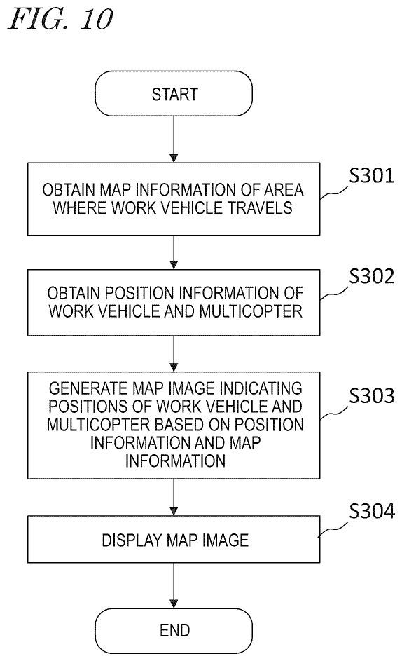

FIG. 10 is a flowchart showing an example of processing executed by the processor 34 (processor) in the controller 120. In this example, the processor 34 obtains information about a map of the area where the work vehicle 100 is located, generates a map image that overlays the positions of the work vehicle 100 and unmanned aerial vehicle 10 on the map, and displays the map image in the field of the display 170.

In step S301, the processor 34 obtains map information of the area where the work vehicle 100 travels. The map information is previously stored in the storage device 37 of the controller 120. The map information may include, for example, position information (such as latitude and longitude) of the field and surrounding topographical features where the work vehicle 100 travels. The processor 34 obtains the map information from the storage device 37. Note that the processor 34 may also obtain map information from an external device such as server 300.

In step S302, the processor 34 obtains position information of the work vehicle 100 and the multicopter 10. The processor 34 obtains position information of the work vehicle 100 output from a positioning device such as the GNSS receiver 130 in the work vehicle 100. The processor 34 obtains position information of the multicopter 10 output from a positioning device such as the GNSS receiver 41 of the multicopter 10 via the communication devices 4c and 110.

In step S303, the processor 34 generates a map image that overlays the positions of the work vehicle 100 and the multicopter 10 on the map based on the position information and map information. The map image may be an image that superimposes icons indicating the positions of the work vehicle 100 and the multicopter 10 on a map of the field. The processor 34 may also obtain speed information of the work vehicle 100 and the multicopter 10 in addition to the position information, and generate a map image that further shows the direction of movement of the work vehicle 100 and the multicopter 10 based on the speed information.

In step S304, the processor 34 displays the generated map image on the display 170. The processor 34 may display a moving image showing changes in the positions of the work vehicle 100 and the multicopter 10 on the display 170 by repeatedly executing the operations from steps S301 to S304.

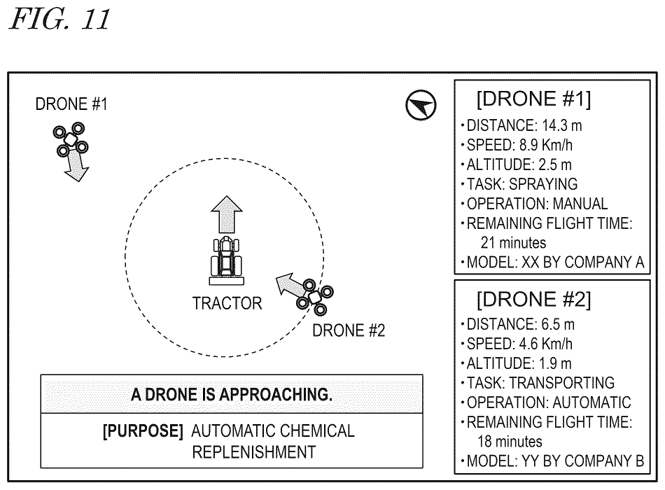

FIG. 11 shows an example of a map image displayed on the display 170. In this example, two multicopters 10 (Drone #1 and Drone #2) are flying around the work vehicle 100, which is a tractor. The processor 34 in the work vehicle 100 sequentially receives position information and speed information from each of the two multicopters 10, and displays a map image as shown in FIG. 11 on the display 170. In this example, two multicopters 10 are flying around the work vehicle 100, but one or three or more multicopters 10 may be flying around the work vehicle 100.

Communication based on distance, as described earlier, may be performed between the work vehicle 100 and each multicopter 10, or communication sharing necessary information such as identifiers (IDs) and position information may be performed regardless of distance. Information about multicopters 10 that do not perform collaborative work with the work vehicle 100, not just multicopters 10 that perform collaborative work with the work vehicle 100 as described earlier, may be transmitted to the work vehicle 100 and displayed. Communication between the work vehicle 100 and each multicopter 10 may be conducted through direct wireless communication or via a cloud server 300.

In the example of FIG. 11, the processor 34 generates a map image showing the positions and movement directions of each multicopter 10 centered on the position of the work vehicle 100, and displays it on the display 170. More specifically, the processor 34 generates a map image that includes icons for the work vehicle 100 and each multicopter 10, and arrows indicating the movement directions of the work vehicle 100 and each multicopter 10, and displays it on the display 170. The processor 34 may obtain flight path information from each multicopter 10 and generate and display on the display 170 a map image that includes information about future flight paths. The processor 34 sequentially obtains position information and speed information of the work vehicle 100 and each multicopter 10, and sequentially updates the display of the positions and movement directions of the work vehicle 100 and each multicopter 10 in the map image. Information transmitted from each multicopter 10 to the work vehicle 100 includes the ID of that multicopter 10. The work vehicle 100 can identify information from individual multicopters 10 based on those IDs.

In the example shown in FIG. 11, the processor 34 obtains operation information indicating the operating state of each multicopter 10 and, based on this operation information, displays the operating state of each multicopter 10 on the display 170 along with the map image. On the right side of FIG. 11, examples of the operating states of the two multicopters 10 (Drone #1 and Drone #2) are shown. The operating state may include at least one of: the content of the work being performed by the multicopter 10 (spraying, transport, mowing, etc.), whether the multicopter 10 is flying in autonomous mode (unmanned operation), the remaining flight time of the multicopter 10 (or energy remaining), and the energy remaining of the multicopter 10. In the example of FIG. 11, the operating information includes the distance from the work vehicle 100, altitude, work content, operation mode (automatic or manual operation), and remaining flight time for each multicopter 10. In the example of FIG. 11, the model name (manufacturer and model number, etc.) identified from the ID of each multicopter 10 is also displayed.

In the example of FIG. 11, a dashed circle indicating a predetermined distance range from the position of the work vehicle 100 is shown. The processor 34 may output a warning (alert) to the display 170 if any multicopter 10 enters within the predetermined distance range from the position of the work vehicle 100. In the example of FIG. 11, one multicopter 10 (Drone #2) has approached the work vehicle 100 and entered within the predetermined distance range. At this time, the processor 34 displays the message “A DRONE IS APPROACHING.” as an alert on the display 170. When a multicopter 10 is intentionally approaching the work vehicle 100 for collaborative work, the work purpose may be displayed. The processor 34 may display information indicating the purpose of the multicopter's approach (for example, automatic chemical replenishment) on the display 170, as shown in FIG. 11.

The alert is not limited to display on the display 170, but may be expressed, for example, by a warning sound from a speaker, light from a light source, or vibration. The alert may change depending on the distance between the work vehicle 100 and the multicopter 10. For example, the processor 34 may change the interval of warning sounds, vibrations, or light alerts according to the distance between the work vehicle 100 and the multicopter 10. As one example, as the multicopter 10 approaches the work vehicle 100, when the distance falls below a first threshold, an intermittent sound with long intervals such as “beep, . . . beep, . . . ” may be output as an alert, and when the distance falls below a second threshold smaller than the first threshold, an intermittent sound with short intervals such as “beep, beep, beep” may be output as an alert. Note that the distance between the work vehicle 100 and the multicopter 10 may be a distance in three-dimensional space or a distance in plan view.

Note that in the examples of FIGS. 10 and 11, the processor 34 displays a map image that overlays the positions of the work vehicle 100 and each unmanned aerial vehicle 10 on a map on the display 170, but is not limited to such a display. The positions of the work vehicle 100 and each multicopter 10 may be displayed in other formats, such as a radar display.

Thus, the display system in this example embodiment displays an image showing the relative positional relationship between a work vehicle 100 capable of ground operations and one or more multicopters 10 positioned around it (for example, within a certain distance range) on the display 170. This enables the user of the work vehicle 100 (for example, the driver or supervisor) to grasp information such as the position and speed of multicopters 10 existing around the work vehicle 100. When the work vehicle 100 is, for example, a tractor with a cabin, and the user is riding in the tractor, it is generally difficult for the user to accurately grasp the positions of surrounding multicopters 10. By adopting the display system of this example embodiment, it becomes easier for the user to immediately grasp the position of each surrounding multicopter 10.

Note that in the above example, the position of the work vehicle 100 is centered and information such as the positions of one or more multicopters 10 around it is displayed, but a similar display may be made with the position of a specific multicopter 10 as the center. In that case, an image including position information of one or more multicopters 10 and one or more work vehicles 100 existing around the specific multicopter 10 may be displayed on the display 170.

In this example embodiment, the processor 34 included in the controller 120 of the work vehicle 100 generates a map image including information such as the positions of the work vehicle 100 and the multicopter 10, but other processors may execute this processing. For example, the processor 320 in the server 300 may receive necessary information from each of the work vehicle 100 and the multicopter 10, generate a map image based on that information, and transmit it to the display 170. Alternatively, a processor included in the display 170 may generate and display the map image. Similar displays may be made on displays other than the display 170 in the work vehicle 100, such as display terminals for remote monitoring of the work vehicle 100 or the multicopter 10.

The work vehicles according to the above example embodiments are not limited to agricultural machinery such as tractors but may be construction machinery. For example, the communication method and display method of this disclosure may be applied to systems each including one or more work vehicles for construction and civil engineering, such as backhoes, wheel loaders, carriers, etc., and one or more unmanned aerial vehicles.

Unmanned aerial vehicles according to example embodiments of the present disclosure may be widely utilized not only for applications such as aerial photography, surveying, logistics, and agricultural spraying, but also for ground work related to agricultural work, and transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A display system configured to display, on a display, positions of a work vehicle and one or more unmanned aerial vehicles that are flying around the work vehicle, the display system comprising:
a processor configured or programmed to obtain position information of the work vehicle and the unmanned aerial vehicles, and to display the positions of the work vehicle and the unmanned aerial vehicles in a field displayed on the display, based on the position information.

2. The display system according to claim 1, wherein the processor is configured or programmed to further obtain speed information of the work vehicle and the unmanned aerial vehicles, and based on the speed information, to display, in the field, movement directions of the work vehicle and the unmanned aerial vehicles together with the positions of the work vehicle and the unmanned aerial vehicles.

3. The display system according to claim 2, wherein the processor is configured or programmed to display the position and the movement direction of each of the unmanned aerial vehicles with the position of the work vehicle as a center in the field.

4. The display system according to claim 2, wherein the processor is configured or programmed to display icons of the work vehicle and each of the unmanned aerial vehicles, and arrows indicating the movement directions of the work vehicle and each of the unmanned aerial vehicles in the field.

5. The display system according to claim 2, wherein the processor is configured or programmed to sequentially obtain the position information and the speed information of the work vehicle and each of the unmanned aerial vehicles, and sequentially update the display of the positions and the movement directions of the work vehicle and each of the unmanned aerial vehicles in the field.

6. The display system according to claim 1, wherein the processor is configured or programmed to further obtain operation information indicating an operating state of each of the unmanned aerial vehicles, and based on the operation information, display the operating state of each of the unmanned aerial vehicles on the display together with the field.

7. The display system according to claim 6, wherein the operating state includes at least one of content of the work being performed by the unmanned aerial vehicle, whether the unmanned aerial vehicle is flying in autonomous mode, a remaining flight time of the unmanned aerial vehicle, or a remaining energy of the unmanned aerial vehicle.

8. The display system according to claim 1, wherein the processor is configured or programmed to output an alert to the display when any unmanned aerial vehicle is within a predetermined distance from the position of the work vehicle.

9. The display system according to claim 1, wherein the processor is configured or programmed to obtain information of a map of an area where the work vehicle is located, generate a map image that overlays the positions of the work vehicle and the unmanned aerial vehicles on the map, and display the map image in the field.

10. The display system according to claim 1, further comprising the display.

11. A work vehicle comprising the display system according to claim 1.

12. A display method in a system including a work vehicle and one or more unmanned aerial vehicles flying around the work vehicle, the display method comprising:
obtaining position information of the work vehicle and the unmanned aerial vehicles; and
displaying positions of the work vehicle and the unmanned aerial vehicles in a field shown on a display based on the position information.
